(19) United States
(12) Patent Application Publication
(10) Pub. No.: US 2016/0267439 A1
(43) Pub. Date: Sep. 15, 2016

(54) CONTEXTUAL CALENDAR CONFLICT RESOLUTION

(71) Applicant: Microsoft Technology Licensing, LLC, Redmond, WA (US)

(72) Inventors: Hadas Bitran, Ramat Hasharon (IL); Delia Koren, Tel Aviv (IL); Omri Koshorek, Tel Aviv (IL); Elinor Axelrod, Hod Hasharon (IL); Limor Lahiani, Tel Aviv (IL); Uri Barash, Tel Mond (IL); Ido Priness, Kiryat Ono (IL); Dikla Dotan-Cohen, Netanya (IL); Adi Miller, Ramat Hasharon (IL); Haim Somech, Ramat Gan (IL)

(21) Appl. No.: 14/644,823

(22) Filed: Mar. 11, 2015

(51) Int. Cl. G06Q 10/10

(52) U.S. Cl. CPC G06Q 10/1095

(57) ABSTRACT

An electronic calendaring system provides contextual calendar conflict resolution by dynamically evaluating the contexts of a user's obligations and offering the user assistance in scheduling non-conflicting events in a calendar. The electronic calendaring system generates one or more electronic calendar conflict resolution options based on contextual information associated with conflicting calendar events. An event conflict evaluator identifies a calendar conflict between at least two calendar events within received calendar event information. An event context evaluator collects contextual information about the conflicting calendar events. A conflict resolution mediator ranks available time slots to which at least one of the conflicting calendar events can be rescheduled based on the collected contextual information. The conflict resolution mediator further communicates a conflict resolution option message via a user interface of a computing device. The conflict resolution option message proposes at least one of the ranked time slots to resolve the calendar conflict.

### BACKGROUND

Human activity is often scheduled within calendaring programs and/or services by interaction of a user, such as through a user's workstation, laptop computer, gaming console, wearable device, and/or other mobile device. However, sources of competing obligations are growing ever more numerous and can easily lead to calendar conflicts, such as overlapping meetings and missed events, whether the conflicting obligations are explicitly captured within the calendar or not. For example, important office meetings can compete with less important office meetings, professional travel arrangements, family commitments, social events, etc. Resolving calendar conflicts in these numerous contexts, whether one is trying to schedule one or more participants for a particular event or one is receiving an invitation for such an event, is increasingly challenging, especially as users become more connected with each other and sources of competing obligations become more invasive.

### SUMMARY

The described technology provides contextual calendar conflict resolution by dynamically evaluating the contexts of the user's obligations and preferences, and offering the system-implemented assistance in scheduling non-conflicting and convenient events in a calendar. An electronic calendaring system manages one or more electronic calendar databases for recording one or more calendar events. The electronic calendaring system generates one or more electronic calendar conflict resolution options (e.g., alternative time slots for rescheduling one or more conflicting calendar events) based on contextual information associated with conflicting calendar events. An event conflict evaluator receives calendar event information from the one or more electronic calendar databases and identifies a calendar conflict between at least two calendar events within the received calendar event information. An event context evaluator receives the calendar event information associated with the at least two conflicting calendar events and collects contextual information about the at least two conflicting calendar events.

A conflict resolution mediator receives the calendar event information and the collected contextual information and ranks available time slots to which at least one of the conflicting calendar events can be rescheduled based on the collected contextual information. The conflict resolution mediator further communicates a conflict resolution option message via a user interface of a computing device. The conflict resolution option message proposes at least one of the ranked time slots to resolve the calendar conflict. A conflict resolution implementer accesses the calendar event information in the one or more electronic calendar databases, receives a resolution response to the conflict resolution option message via the user interface, and communicates a scheduling instruction to the electronic calendaring system to schedule at least one of conflicting calendar events based on the resolution response.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates an example electronic calendaring system resolving a calendar conflict detected within electronic calendar information.

FIG. 2 illustrates an example electronic calendaring system resolving a calendar conflict between a meeting invitation and an explicit calendar event.

FIG. 3 illustrates an example electronic calendaring system resolving a calendar conflict between a meeting invitation and an inferred calendar event.

FIG. 4 illustrates an example electronic calendaring system resolving a calendar conflict between an explicit calendar event and an inferred calendar event.

FIG. 5 illustrates an example electronic calendaring system resolving a calendar conflict between a scheduling assistant view of an explicit calendar and an inferred calendar event.

FIG. 6 illustrates an example contextual calendar resolution process based on a calendar conflict.

FIG. 7 illustrates an example user interface used to interact with a user for contextual calendar resolution.

FIG. 8 illustrates example operations for performing contextual calendar conflict resolution.

FIG. 9 illustrates an example system useful for performing contextual calendar conflict resolution.

### DETAILED DESCRIPTIONS

The described technology provides contextual calendar conflict resolution that can infer non-explicit calendar events and missing calendar event parameters to generate and propose calendar conflict resolution options within an electronic calendaring system. Contextual calendar conflict resolution, such as by ranking available time slots, prioritizing calendar events, inferring calendaring events and missing parameters, and/or providing pre-processed options for resolving detected calendar conflicts improves electronic calendaring system performance, effectiveness, and usability.

Calendar conflict resolution may include without limitation adjusting one or more calendar events, optimizing calendar events for user convenience or based on user preferences, and accepting a conflict as acceptable (e.g., a user may accept an invitation for a phone call scheduled during a scheduled all day conference, even though the two calendar events overlap—the user can just step out of the conference to take the call, so the conflict is deemed to be acceptable and therefore resolved). In this manner, the inferred calendar information can enhance the contextual information provided with explicit calendar events and provide a rich and well-informed set of options to a user when attempting to resolve a calendar conflict. As a result, a user can more efficiently evaluate calendar conflicts and provide calendar conflict resolution instructions based on the enhanced information and proposed options. Responsive to the user's instructions, the electronic calendaring system adjusts the conflicting calendaring events to resolve the conflict.

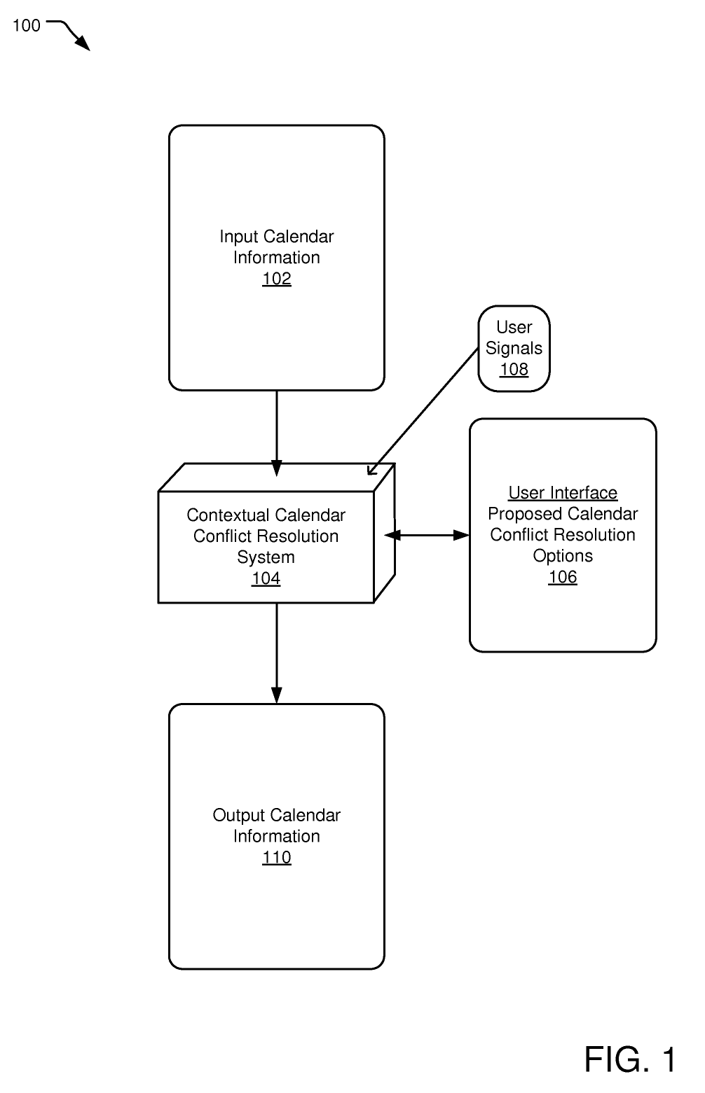

FIG. 1 illustrates an example electronic calendaring system 100 resolving a calendar conflict detected within electronic calendar information. In one implementation, a calendar conflict is detected with an overlap between calendar events is identified. As discussed below, calendar events may include without limitation explicit calendar events (e.g., calendar events entered into the explicit calendaring databases by the user or a delegate, meeting invitations) and inferred calendar events (e.g., events identified based on prior user behavior and other user signals, such as geographic travel and/or location patterns, inferred travel time between explicit or inferred calendar event locations, etc.).

Calendar events are stored in one or more calendaring databases or received as messages (e.g., meeting invitations), as represented as input calendar information 102, which is received as input by a contextual calendar conflict resolution system 104 of the electronic calendaring system 100. User signals 108 (as discussed later) can also be received by the contextual calendar conflict resolution system 104 to infer calendar events and event parameters that can be used to propose calendar conflict resolution options (e.g., potential time slots for rescheduling one or more conflicting calendar events) through a user interface 106. In the illustrated example, the contextual calendar conflict resolution system 104 ranks available time slots to propose conflict resolution options that best accommodate user preferences and other calendar events and calendar event parameters.

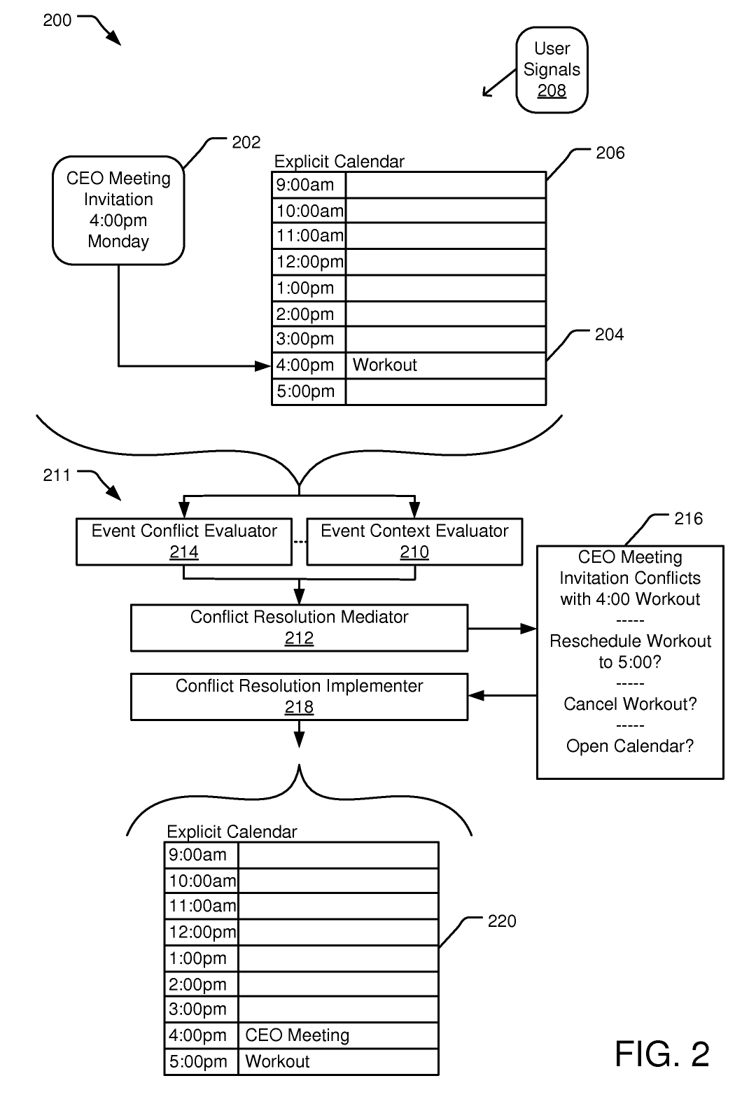

The contextual calendar conflict resolution system 104 receives conflict resolution instructions from the user interface 106 and applies the conflict resolution instructions to output calendar information 110. For example, the contextual calendar conflict resolution system 104 may reschedule an existing explicit calendar event, delete or ignore an inferred calendar event, transmit a counteroffer for a meeting request proposing a different time slot or location, etc. More detailed calendar conflict resolution examples are provided with respect to FIGS. 2-5.

FIG. 2 illustrates an example electronic calendaring system 200 resolving a calendar conflict between a meeting invitation 202 and an explicit calendar event 204. The meeting invitation 202, also referred to as a scheduling request, represents a type of unscheduled or “not-yet-scheduled” calendar event within the electronic calendaring system 200. The explicit calendar event 204 represents a scheduled calendar event recorded in one or more electronic calendar databases (e.g., represented as explicit electronic calendar 206) of the electronic calendaring system 200. Example calendar events may include without limitation meetings, activities, tasks, deadlines, reserved periods of time, meeting invitations, and other calendar events. The explicit calendar event 204 is recorded in the explicit electronic calendar 206 via various explicit calendaring actions, including without limitation:
by a user's entry of the event in his or her electronic calendaring system;
by another user's entry of the event into the first user's electronic calendaring system (e.g., through delegation of calendaring rights to the other user);
by an electronic invitation message for the event sent to the user's electronic calendaring system (e.g., whether the invitation has been accepted or has yet to be declined).

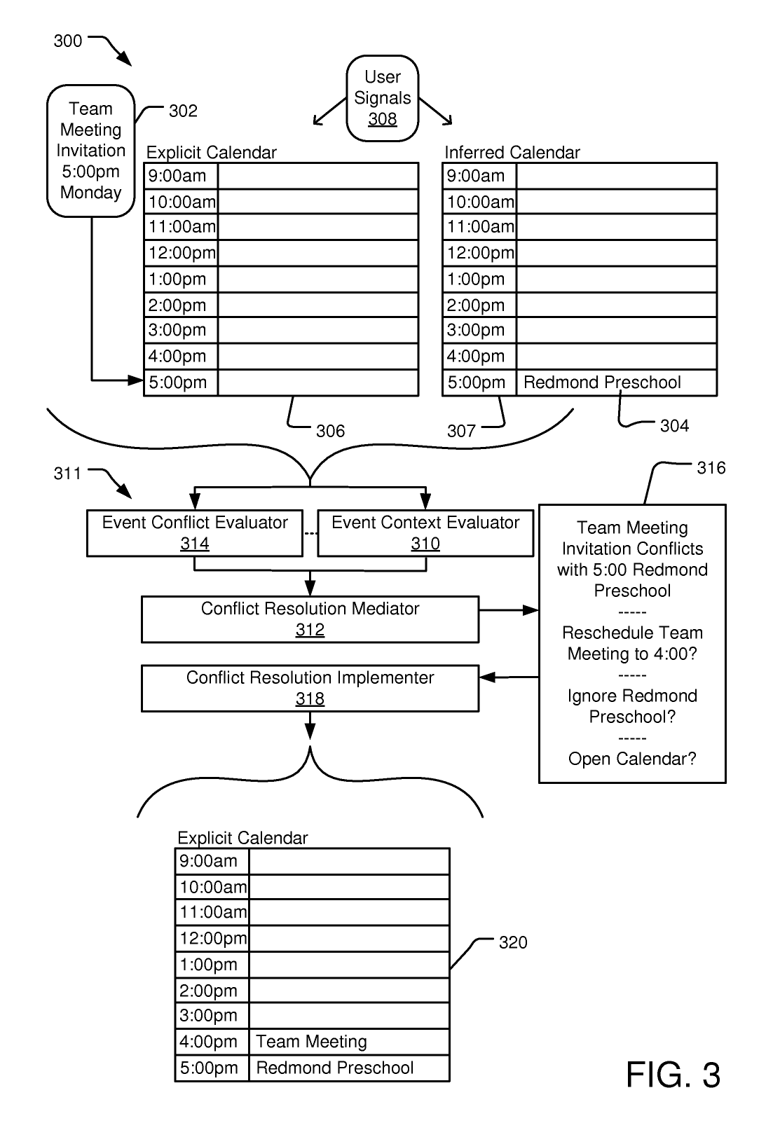

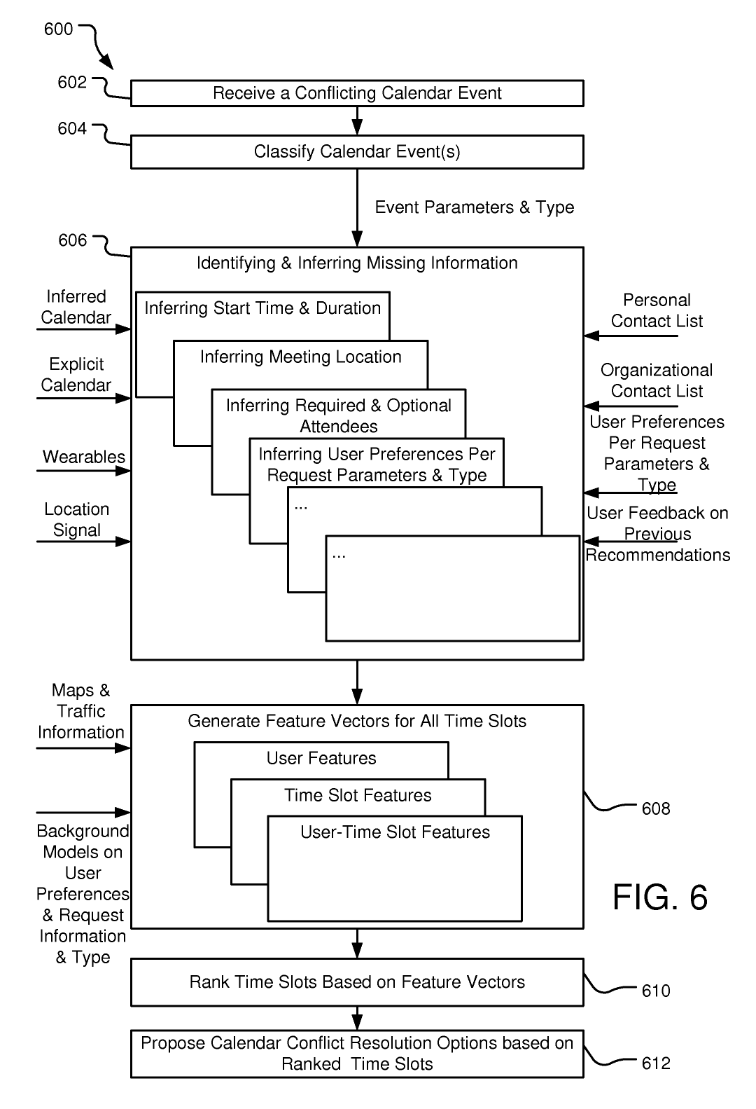

The explicit electronic calendar 206, however, may not reflect or incorporate certain unrecorded obligations, conflicting appointments, travel time, etc. Therefore, an inferred electronic calendar (not shown—see FIGS. 3, 4, and 5) may be recorded in one or more electronic calendar databases and included in the contextual calendar conflict resolution process. In addition, the explicit calendar event 204 and the meeting invitation 202 may not include certain relevant parameters useful for resolving calendar conflicts. As such, such missing parameters may also be inferred from explicit calendars, inferred calendars and other sources, including without limitation user signals 208. User signals 208 represent signals about a user that are received by the electronic calendaring system 200 from outside the electronic calendaring system 200. A description of inferring missing parameters is provided with regard to FIG. 6.

The electronic calendaring system 200 collects and/or infers explicit calendar events, inferred (e.g., unrecorded) calendar events, and/or explicit and inferred calendar event parameters to generate and propose (a) alternative time slots in which to move explicitly scheduled and/or inferred calendar events and (b) counteroffer time slots in response to conflicting meeting invitations. Contextual information for such calendar conflict resolution may be collected based on explicit or inferred calendar event information and on user signals 208, which are received from sources external to the calendar event itself. More details about contextual information are provided at least with regard to FIG. 6.

An event conflict evaluator 214 monitors explicit calendars and inferred calendars within the electronic calendaring system 200 as well as scheduling requests and user signals 208 to identify potential calendar conflicts. In one implementation, potential calendar conflicts can be identified when their scheduled, inferred, or proposed time slots overlap. Other potential calendar conflicts may also be identified, such as when an insufficient amount of time is available between calendar events to travel from the location of the first calendar event to the next calendar event. Other calendar conflicts may also be identified.

As shown in the example of FIG. 2, the event conflict evaluator 214 monitors the explicit calendar 206 and the meeting invitation 202, detecting that the CEO meeting proposed by the meeting invitation 202 conflicts with the explicit calendar event 204 (“workout”) because the time slots overlap. Based on the detection of the event conflict, the event conflict evaluator 214 signals the detected conflict to a conflict resolution mediator 212. The event conflict evaluator 214 may also signal an event context evaluator 210 of the conflict to trigger collection of additional contextual information.

Periodically, continuously, or in response to a trigger (such as a conflict detection by the event conflict evaluator 214), the event context evaluator 210 monitors explicit calendars and inferred calendars within the electronic calendaring system 200 as well as scheduling requests and user signals 208 received by the electronic calendaring system 200 to determine contextual information for various calendar events. Typically, calendars and events lack certain information that hampers calendar conflict resolution. Accordingly, the event context evaluator 210 infers missing contextual information from available sources to provide a richer data set from which to propose calendar conflict resolution options. In some implementations, inferred contextual information may be fed back into a user's explicit calendar or inferred calendar.

In one implementation, available information about a calendar event (whether a recorded calendar event, an inferred calendar event, or an event invitation) is collected by the event context evaluator 210 and parsed into a structured form, which is used to classify the calendar event into one or more possible event types defined within a pre-defined taxonomy of event types (e.g., business meeting, workout, travel, social event, family time). For example, an invitation entitled “department meeting,” specifying a time slot during a user's workday in an on-site conference room, received from a co-worker and specifying other co-workers as invitees, is more likely to be classified as a “work meeting.” In contrast, an invitation entitled “movie night” specifying a time slot outside of work hours received from a family member is more likely to be classified as a “social event” or “family time.” Through this event classification phase, a calendar event may be classified with an inferred event type within the pre-defined taxonomy to assist with the calendar conflict resolution.

In one implementation, a user may provide feedback for such classification, adding new event types, deleting or modifying event types, changing the classification of a particular event, thereby allowing the event context evaluator 210 to better classify future meetings based on the user feedback. A classification of an event may be annotated by a confidence level resulting from the classification operation (e.g., the higher the classification score relative to a resulting event type, the higher the confidence level for that event's classification).

In the example of FIG. 2, the meeting invitation 202 specifies “CEO meeting” at 4:00 pm Monday. By parsing the invitation phrase “CEO meeting” and recognizing the workday timeslot, the event context evaluator 210 classifies the meeting invitation 202 to be a “business meeting” type, passing the identified type and the parsed tokens and other parameters (e.g., “CEO,” “meeting,” “CEO meeting,” 4:00 pm on Monday) to a next inference phase that infers missing parameters associated with the meeting invitation 202.

Parameters that are not explicitly included in a calendar event can be inferred by the event context evaluator. The event context evaluator 210 first identifies parameters missing from the calendar event record and then infers one or more of the missing parameters based on other aspects of the calendar event, other calendars, and from user signals 208. Examples of parameters that may be missing from a calendar event (whether the calendar event is explicit, inferred, or an invitation) includes without limitation:
Start time of the meeting, including day of week and time of day
Location of the meeting
Duration of the meeting
Required attendees
Optional attendees
Meeting Priority (e.g., Mandatory, Optional)

If a user sends the meeting invitation 202 to co-workers for a CEO meeting starting at 4:00 pm but does not specify a meeting location, the meeting location is identified as a missing parameter and may be inferred from other contextual information within the meeting invitation, other calendars, and user signals 208. The sender, receiver(s), the time slot, and the identified type of the meeting invitation 202 in addition to the scheduled locations of the sender and receiver(s) can be evaluated to suggest a meeting location during a conflict resolution operation. For example, if the event context evaluator 210 determines from the other invitees' calendars that all or most of the invitees are scheduled to be in the same office at 4:00 pm on Monday, the event context evaluator 210 can infer that an available conference room in that office is an appropriate meeting location and signal the conflict resolution mediator 212 to propose (and potentially reserve) the conference room until a user changes or confirms the meeting location. In contrast, if one or more invitees are scheduled to be out of the office at 4:00 pm on Monday, the conflict resolution mediator 212 can schedule a teleconference and/or reserve a conference room, as appropriate, to accommodate more of the invited participants who have accepted the invitation (e.g., some attendees may attend in person and others may attend via teleconference).

In order to infer the missing parameters, the event context evaluator 210 interprets information from each user's explicit and inferred calendars and various user signals 208, including without limitation email content, social media content, on-line service information, current and historical GPS information and trends, historical user feedback relating to similar calendar events, contact lists from private or organizational sources, user preferences, etc. Part of the contextual information (e.g., type of event) about a calendar event, though absent in the calendar event itself, may be inferred from the explicit information included with the calendar event (e.g., calendar events scheduled in the temporal proximity of another calendar event). Other parameters may also be inferred through the event classification phase if they are not explicitly recorded in the calendar event, including location (e.g., at the office, at home, at an identified restaurant, at an identified customer site), travel time (e.g., travel time between two temporally proximate calendar events), attendee focus (e.g., are there only two attendees or many attendees?), whether attendance is mandatory (e.g., have many people declined to attend?), etc.

The user signals 208 allow the event context evaluator 210 to infer missing parameters for a calendar event (e.g., meeting invitation 202) to provide richer contextual information for conflict resolution.

For example, user signals 208 may include information from a received email from a travel service confirming a travel itinerary. The information in the email may be parsed from the email text, provided as metadata in association with the email, obtained through a travel service API, etc.

The event conflict evaluator 214 passes conflict information about the conflicting calendar events to a conflict resolution mediator 212. In addition, having inferred and/or collected additional available context information about the conflicting calendar events, the event context evaluator 210 passes the context information, if any, to a conflict resolution mediator 212. Contextual information may include the duration and location of the CEO meeting (assuming it is not specified in the meeting invitation 202), the priority of the CEO meeting, etc. Such contextual information may be inferred from past CEO meetings in the user's electronic calendaring system 200, emails referring to the CEO meeting, a document in a collaborative documentation system providing an agenda for the CEO meeting, etc.

The conflict resolution mediator 212 collects the provided conflict information and additional context information, if any, to develop one or more proposed conflict resolution options for presentation to the user experiencing the calendar conflict. As described at least with regard to FIG. 6, the conflict resolution mediator 212 can prioritize individual calendar events and rank available time slots that can be presented to a user as reasonable rescheduling options, as shown in a user interface sample 216 (e.g., displayed on a computer, smart phone, wearable electronic device, etc.). In the example shown in FIG. 2, the conflict resolution mediator 212 has inferred that the CEO meeting is a higher priority than the workout and offers conflict resolution options relating to rescheduling or canceling the workout in favor of the CEO meeting. The conflict resolution options presented to the user in the user interface sample 216 include rescheduling the workout to a 5:00 time slot, canceling the workout, or opening the calendar to allow the user to take a more explicit conflict resolution action. In the case of the 5:00 time slot, the conflict resolution mediator 212 ranked the 5:00 time slot as the best time slot to reschedule the workout, compared to all other available workout time slots.

Instructions provided through the user interface, whether through the suggested options or through the electronic calendaring system 200, are passed to a conflict resolution implementer 218, which adjusts any calendaring events as appropriate, proposes a better time or location for the CEO meeting, etc. The conflict resolution implementer 218 records the result of the conflict resolution in the updated version of the explicit calendar 220.

The event conflict evaluator 214, the event context evaluator 210, the conflict resolution mediator 212, and the conflict resolution implementer 218 represent example components of an example contextual calendar conflict resolution system 211.

FIG. 3 illustrates an example electronic calendaring system 300 resolving a calendar conflict between a meeting invitation 302 and an inferred calendar event 304. The meeting invitation 302, also referred to as a scheduling request, represents a type of unscheduled or “not-yet-scheduled” calendar event within the electronic calendaring system 300. An explicit calendar 306 includes explicitly scheduled calendar events recorded in one or more electronic calendar databases of the electronic calendaring system 300.

The explicit electronic calendar 306, however, may not take into consideration or incorporate certain unrecorded obligations, conflicting appointments, travel time, etc. Therefore, an inferred electronic calendar 307 may be recorded in one or more electronic calendar databases and included in the contextual calendar conflict resolution process. The inferred calendar event 304 represents an un-scheduled calendar event that has been inferred by the electronic calendaring system 300 based on past calendaring records (e.g., recorded in an explicit calendar 306 in some discernable pattern) and user signals 308 (e.g., GPS location patterns, text messages between the Redmond Preschool and the user regarding a sick student pick-up request). User signals 308 represent signals about a user that are received from outside the electronic calendaring system 300. Accordingly, while no conflict is detected between the meeting invitation 302 and the explicit calendar 306, the electronic calendaring system 300 may detect a conflict between the meeting invitation 302 and the inferred calendar 307 and provide contextual calendar conflict resolution options (e.g., alternative time slots for rescheduled one or more calendar events) to the user.

In addition, the inferred calendar event 304 and the meeting invitation 302 may not include certain relevant parameters useful for resolving calendar conflicts. As such, such missing parameters may also be inferred from explicit calendars, inferred calendars and other sources, including without limitation user signals 308. Such inferred information or parameters can be useful in providing enhanced conflict resolution options to a user.

The electronic calendaring system 300 collects and/or infers explicit calendar events, inferred (e.g., unrecorded) calendar events, and/or explicit and inferred calendar event parameters to generate and propose (a) alternative time slots in which to move explicitly scheduled and/or inferred calendar events and (b) counteroffer time slots in response to conflicting meeting invitations. Contextual information for such calendar conflict resolution may be collected based on explicit or inferred calendar event information and on user signals 208, which are received from sources external to the calendar event itself.

An event conflict evaluator 314 monitors explicit calendars and inferred calendars within the electronic calendaring system 300 as well as scheduling requests and user signals 308 to identify potential calendar conflicts. As shown in FIG. 3, the event conflict evaluator 314 monitors the explicit calendar 306, the inferred calendar 307, and the meeting invitation 302, detecting that the team meeting proposed by the meeting invitation 302 conflicts with the inferred calendar event 304 (“Redmond Preschool”) because the time slots overlap. Based on the detection of the event conflict, the event conflict evaluator 314 signals the detected conflict to a conflict resolution mediator 312. The event conflict evaluator 314 may also signal an event context evaluator 310 of the conflict to trigger collection of additional contextual information.

Periodically, continuously, or in response to a trigger (such as a conflict detection by the event conflict evaluator 314), the event context evaluator 310 monitors explicit calendars and inferred calendars within the electronic calendaring system 300 as well as scheduling requests and user signals 308 received by the electronic calendaring system 300 to determine contextual information for various calendar events. Typically, calendars and events lack certain information that hampers calendar conflict resolution. Accordingly, the event context evaluator 310 infers missing contextual information from available sources to provide a richer data set from which to propose calendar conflict resolution options. In some implementations, inferred contextual information may be fed back into a user's explicit calendar or inferred calendar. One example of contextual information includes calendar event classification, as discussed with regard to FIG. 2.

In the example shown in FIG. 3, the meeting invitation 302 specifies “Team meeting” at 5:00 pm Monday. By parsing the invitation phrase “team meeting” and recognizing the workday timeslot, the event context evaluator 310 classifies the meeting invitation 302 to be a “business meeting” type, passing the identified type and the parsed tokens and other parameters (e.g., “team,” “meeting,” “team meeting,” 5:00 pm on Monday) to a next inference phase that infers missing parameters associated with the meeting invitation 302.

Parameters that are not explicitly included in a calendar event can be inferred by the event context evaluator. The event context evaluator 310 first identifies parameters missing from the calendar event record and then infers one or more of the missing parameters based on other aspects of the calendar event, other calendars, and from user signals 308, as described with regard to FIG. 2. The user signals 308 allow the event context evaluator 310 to infer missing parameters for a calendar event (e.g., meeting invitation 302) to provide richer contextual information for conflict resolution.

The event conflict evaluator 314 passes conflict information about the conflicting calendar events to a conflict resolution mediator 312. In addition, having inferred and/or collected additional available context information about the conflicting calendar events, the event context evaluator 310 passes the context information, if any, to a conflict resolution mediator 312. Contextual information may include the duration and location of the team meeting (assuming it is not specified in the meeting invitation 302), the priority of the team meeting, etc. Such contextual information may be inferred from past team meetings in the user's electronic calendaring system 300, emails referring to the team meeting, a document in a collaborative documentation system providing an agenda for the team meeting, etc.

The conflict resolution mediator 312 collects the provided conflict information and additional context information, if any, to develop one or more proposed conflict resolution options for presentation to the user experiencing the calendar conflict. As described at least with regard to FIG. 6, the conflict resolution mediator 312 can prioritize individual calendar events and rank available time slots that can be presented to a user as reasonable rescheduling options, as shown in a user interface sample 316 (e.g., displayed on a computer, smart phone, wearable electronic device, etc.). In the example shown in FIG. 3, the conflict resolution mediator 312 has inferred that the team meeting could be a lower priority than the obligation to be at Redmond Preschool and offers conflict resolution options relating to rescheduling the team meeting in favor of the preschool obligation or, in an alternative, canceling the preschool obligation (e.g., if another family member can fulfill the preschool obligation). The conflict resolution options presented to the user in the user interface sample 316 include rescheduling the team meeting to a 4:00 time slot, canceling the preschool obligation, or opening the calendar to allow the user to take a more explicit conflict resolution action. In the case of the 5:00 time slot, the conflict resolution mediator 312 ranked the 4:00 time slot as the best time slot to reschedule the team meeting, compared to all other available time slots.

Instructions provided through the user interface, whether through the suggested options or through the electronic calendaring system 300 are passed to a conflict resolution implementer 318, which adjusts any calendaring events as appropriate, proposes a better time or location for the team meeting, etc. The conflict resolution implementer 318 records the result of the conflict resolution in the updated version of the explicit calendar 320. The user may also be prompted with an option to convert the inferred “Redmond Preschool” event into an explicit event in the updated version of the explicit calendar 320.

The event conflict evaluator 314, the event context evaluator 310, the conflict resolution mediator 312, and the conflict resolution implementer 318 represent example components of an example contextual calendar conflict resolution system 311.

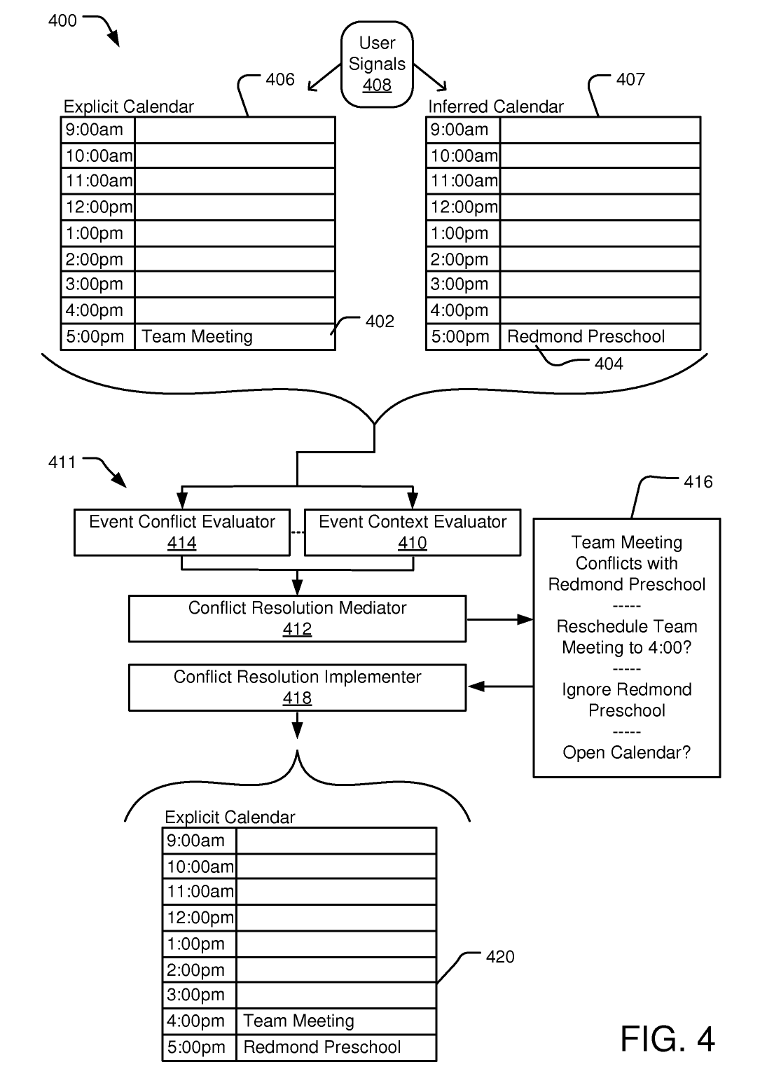

FIG. 4 illustrates an example electronic calendaring system 400 resolving a calendar conflict between an explicit calendar event 402 and an inferred calendar event 404. The explicit calendar event 402 is recorded in an explicit calendar 406, which includes explicitly scheduled calendar events recorded in one or more electronic calendar databases of the electronic calendaring system 400.

The explicit electronic calendar 406, however, may not take into consideration or incorporate certain unrecorded obligations, conflicting appointments, travel time, etc. Therefore, the inferred calendar event 404 is recorded in an inferred electronic calendar 407 in one or more electronic calendar databases and is included in the contextual calendar conflict resolution process. Accordingly, the electronic calendaring system 400 can detect a conflict between the inferred calendar event 404 and the explicit calendar event 402 and provide contextual calendar conflict resolution options to the user.

In addition, the explicit calendar event 402 and the inferred calendar event 404 may not include certain relevant parameters useful for resolving calendar conflicts. As such, such missing parameters may also be inferred from explicit calendars, inferred calendars and other sources, including without limitation user signals 408. Such inferred information or parameters can be useful in providing enhanced conflict resolution options to a user.

The electronic calendaring system 400 collects and/or infers explicit calendar events, inferred (e.g., unrecorded) calendar events, and/or explicit and inferred calendar event parameters to generate and propose (a) alternative time slots in which to move explicitly scheduled and/or inferred calendar events and (b) counteroffer time slots in response to conflicting meetings. Contextual information for such calendar conflict resolution may be collected based on explicit or inferred calendar event information and on user signals 408, which are received from sources external to the calendar event itself.

An event conflict evaluator 414 monitors explicit calendars and inferred calendars within the electronic calendaring system 400 as well as scheduling requests and user signals 408 to identify potential calendar conflicts. As shown in an example in FIG. 4, the event conflict evaluator 414 monitors the explicit calendar 406 and the inferred calendar 407, detecting that the team meeting event 402 in the explicit calendar 406 conflicts with the inferred calendar event 404 (“Redmond Preschool”) in the inferred calendar 407 because the time slots overlap. Based on the detection of the event conflict, the event conflict evaluator 414 signals the detected conflict to a conflict resolution mediator 412. The event conflict evaluator 414 may also signal an event context evaluator 410 of the conflict to trigger collection of additional contextual information.

Periodically, continuously, or in response to a trigger (such as a conflict detection by the event conflict evaluator 414), the event context evaluator 410 monitors explicit calendars and inferred calendars within the electronic calendaring system 400 as well as scheduling requests and user signals 408 received by the electronic calendaring system 400 to determine contextual information for various calendar events. Typically, calendars and events lack certain information that hampers calendar conflict resolution. Accordingly, the event context evaluator 410 infers missing contextual information from available sources to provide a richer data set from which to propose calendar conflict resolution options. In some implementations, inferred contextual information may be fed back into a user's explicit calendar or inferred calendar. One example of contextual information includes calendar event classification, as discussed with regard to FIG. 2.

In the example of FIG. 4, the explicit calendar event 402 specifies a “Team meeting” at 5:00 pm Monday. By parsing the explicit calendar event information for the “team meeting” event 402 and recognizing the workday timeslot, the event context evaluator 410 classifies the team meeting event 402 to be a “business meeting” type, passing the identified type and the parsed tokens and other parameters (e.g., “team,” “meeting,” “team meeting,” 5:00 pm on Monday) to a next inference phase that infers missing parameters associated with the meeting invitation 402.

Parameters that are not explicitly included in a calendar event can be inferred by the event context evaluator. The event context evaluator 410 first identifies parameters missing from the calendar event record and then infers one or more of the missing parameters based on other aspects of the calendar event, other calendars, and from user signals 408, as described with regard to FIG. 2. The user signals 408 allow the event context evaluator 410 to infer missing parameters for a calendar event (e.g., explicit calendar event 402) to provide richer contextual information for conflict resolution.

The event conflict evaluator 414 passes conflict information about the conflicting calendar events to a conflict resolution mediator 412. In addition, having inferred and/or collected additional available context information about the conflicting calendar events, the event context evaluator 410 passes the context information, if any, to a conflict resolution mediator 412. Contextual information may include the duration and location of the team meeting (assuming it is not specified in the explicit calendar event 402), the priority of the team meeting, etc. Such contextual information may be inferred from past team meetings in the user's electronic calendaring system 400, emails referring to the team meeting, a document in a collaborative documentation system providing an agenda for the team meeting, etc.

The conflict resolution mediator 412 collects the provided conflict information and additional context information, if any, to develop one or more proposed conflict resolution options for presentation to the user experiencing the calendar conflict. As described at least with regard to FIG. 6, the conflict resolution mediator 412 can prioritize individual calendar events and rank available time slots that can be presented to a user as reasonable rescheduling options, as shown in a user interface sample 416 (e.g., displayed on a computer, smart phone, wearable electronic device, etc.). In the example shown in FIG. 4, the conflict resolution mediator 412 has inferred that the team meeting could be a lower priority than the obligation to be at Redmond Preschool and offers conflict resolution options relating to rescheduling the team meeting in favor of the preschool obligation or, in an alternative, canceling the preschool obligation (e.g., if another family member can fulfill the preschool obligation) if the user decides on a different prioritization. The conflict resolution options presented to the user in the user interface sample 416 include rescheduling the team meeting to a 4:00 time slot, canceling the preschool obligation, or opening the calendar to allow the user to take a more explicit conflict resolution action. In the case of the 5:00 time slot, the conflict resolution mediator 412 ranked the 4:00 time slot as the best time slot to reschedule the team meeting, compared to all other available time slots.

Instructions provided through the user interface, whether through the suggested options or through the electronic calendaring system 400 are passed to a conflict resolution implementer 418, which adjusts any calendaring events as appropriate, proposes a better time or location for the team meeting, etc. The conflict resolution implementer 418 records the result of the conflict resolution in the updated version of the explicit calendar 420. The user may also be prompted with an option to convert the inferred “Redmond Preschool” event into an explicit event in the updated version of the explicit calendar 420.

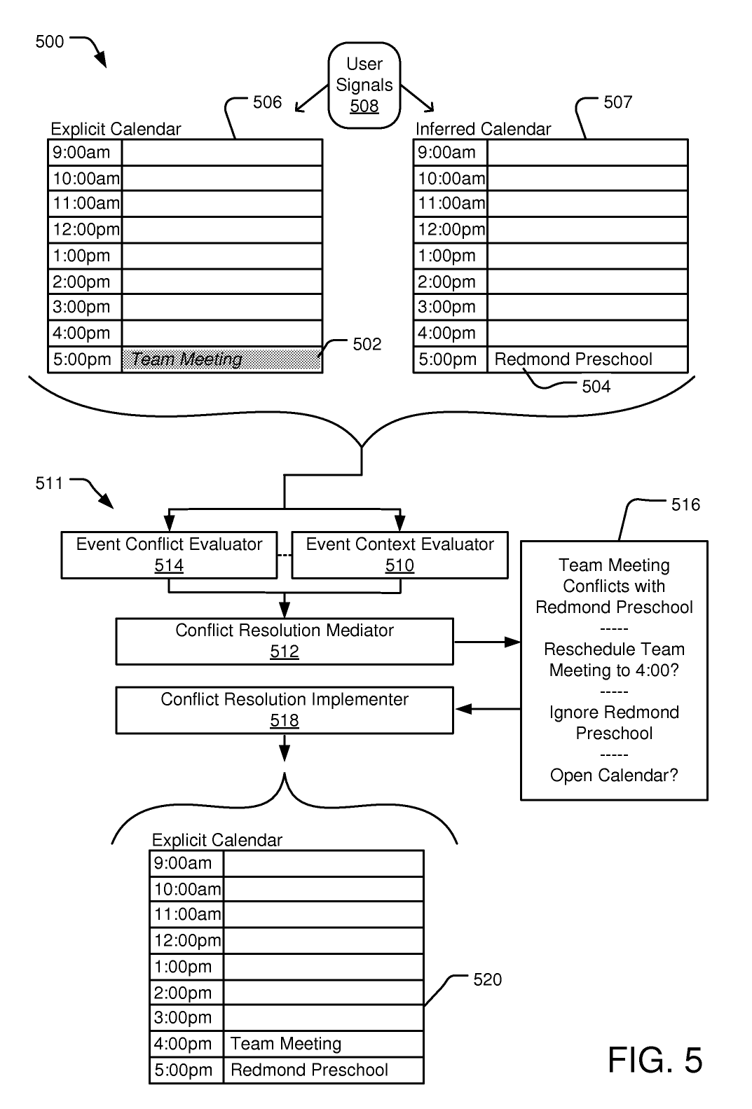

FIG. 5 illustrates an example electronic calendaring system 500 resolving a calendar conflict between a scheduling assistant view of an explicit calendar 506 and an inferred calendar event 504. Although the explicit calendar event 506 is not yet recorded in the electronic calendaring system 500, the inferred calendar event 504 is included in an inferred calendar 507 recorded in the one or more databases of the electronic calendaring system 500. Accordingly, the scheduling assistant view provides a shaded time slot at 5:00 in the explicit calendar 506 to reflect the possibility of an inferred calendar event 504 occupying the same time slot. When the explicit calendar event 502 for the time is recorded in the explicit calendar 506 (e.g., by the user's assistant), the team meeting becomes an explicit calendar event 502 in the explicit calendar 506, which results in a potential calendar conflict with the inferred calendar event 504. In summary, some portion of the inferred calendar information can be reflected in the explicit calendar 502 to give a notice in a scheduling assistant that an unscheduled yet potential (inferred) calendar event may occupy a time slot in a user's day.

An event conflict evaluator 514 monitors explicit calendars and inferred calendars within the electronic calendaring system 500 as well as scheduling requests and user signals 508 to identify potential calendar conflicts. From this point forward, the contextual calendar conflict resolution process proceeds as described with regard to FIG. 4, with the event conflict evaluator 514 detecting the conflict, the event context evaluator 510 collecting and inferring contexts associated with the calendar events (e.g., based on user signals 508), the conflict resolution mediator 512 prioritizing the calendar events and ranking available timeslots for presentation through a user interface 516, and a conflict resolution implementer 518 recording the calendar conflict resolution (e.g., based on the user input) into an updated version of the explicit calendar 520. The user may also be prompted with an option to convert the inferred “Redmond Preschool” event into an explicit event in the updated version of the explicit calendar 520.

The event conflict evaluator 514, the event context evaluator 510, the conflict resolution mediator 512, and the conflict resolution implementer 518 represent example components of an example contextual calendar conflict resolution system 511.

FIG. 6 illustrates an example contextual calendar resolution process 600 based on a calendar conflict. A receiving operation 602 receives a conflicting calendar event through one of the various mechanisms, such as conflict among or between a meeting invitation, a calendar event added to someone's calendar, an explicit calendar event, and/or an inferred calendar event. A classification operation 604 parses and classifies the conflicting calendar events, if they are not already classified, by parsing the calendar event into a structured form and classifying the event based on a predefined taxonomy of event types (e.g., business meetings, family time, social time, etc.). The classification operation 604 passes explicit event parameters and the event type to an inference operation 606. The inference operation 606 identifies and infers missing parameters based on one or more of:
Parameters from the explicit calendar event in the meeting invitation or explicit calendar
Parameters from the inferred calendar event in the inferred calendar
User signals, such as personal contact lists, organizational contact lists, user preferences, user feedback from previous conflict resolutions, GPS and other sensed signals from wearable devices and other mobile devices, etc. User signals may incorporate the semantic meanings of locations or activities within an inferred calendar (e.g., if the location equals an athletic club, the event may be deemed a “workout;” if the heart rate is accelerated while on a bike path, the event may be deemed “biking;” if the GPS signal indicates travel as a high rate of speed on a road, the event may be deemed “travel time”).

The inference operation 606 may infer various parameters including without limitation an event start time, an event duration, an event location, required and/or optional attendees, user preferences (e.g., priority of one meeting over another), whether a meeting room and/or teleconference are required, etc.

A feature vector generation operation 608 generates a feature vector for each time slot in a calendar space (e.g., during the workday, during a 24 hour day, during a week, etc.). In one implementation, three types of features are employed, although other features and feature combinations may be used in other implementations:
User features—examples:
   Demographics—age group, gender, parental status
   User preferences—prefers to in the evening, prefers to on weekends, prefers to in the morning
   Aggregated user preferences (particularly useful when no previous individual user data is available—personal preferences override or are more heavily weighted than aggregated user preferences)
      Department meetings tend to be scheduled at noon on workdays
      Low attendance rate at department meeting versus high attendance rate at one-on-one meetings
Timeslot features—examples:
   Is the time slot during the workday?
   Is the time slot on a weekend?
   Is the time slot in the morning?
User-time slot features—examples:
   Is the user busy in the specific time slot based on the user's explicit calendar?
   The likelihood that the user will be available in the time slot, based on a probabilistic model that consumes the parameters and features discussed herein, including inferred calendar events and inferred parameters. A lower score indicates that the user is unlikely to be available at the specified or inferred location.
   Meeting importance spectrum—example:
      A score of “0” indicates that there is no event.
      A score of “1” indicates a mandatory event.
   Based on current or scheduled information, can the user physically travel to the next meeting location at the next start time?

Each example feature is associated with a weight, which can be manually set and/or refined iteratively as calendar conflict resolutions are fed back into the electronic calendaring system.

A ranking operation 610 ranks the individual time slots given all features (e.g., user, timeslot and user-timeslot features), with consideration of the assigned feature weights. Various constraints may also be applied to filter out non-viable timeslots (e.g., no department meetings when company offices are closed).

The ranking operation 610 may be implemented as a weighted combination of the different features, applying machine-learning techniques using labeled time slots, or other ranking techniques. An option operation 612 proposed one or more high ranking time slots as options for resolving the calendar conflict for one or more of the conflicting calendar events.

Based on received user instructions provided through a user interface of a computing device, the user's preferred calendar conflict resolution is implemented by rescheduling one or more events, changing the location or means for attending an event (e.g., in person versus by telephone), declining the proposed meeting time and/or location and submitting a counteroffer, etc.

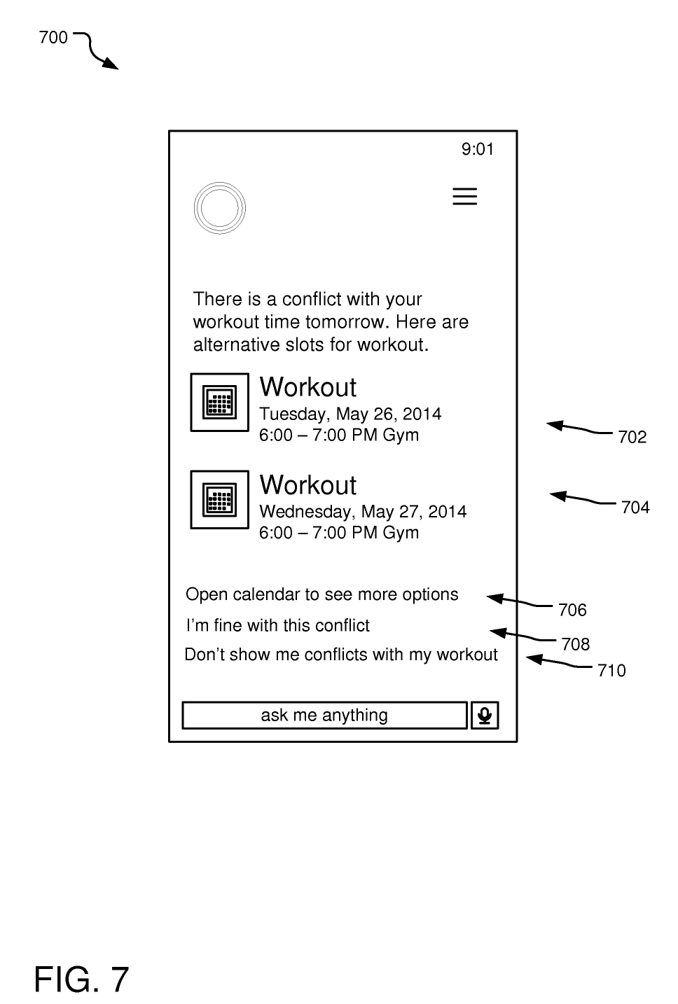

FIG. 7 illustrates an example computing-device-based user interface 700 used to interact with a user for contextual calendar resolution. As shown, the user interface 700 proposes two options: (702) moving a workout to Tuesday from 6:00 pm to 7:00 pm or (704) moving a workout to Wednesday from 6:00 pm to 7:00 pm, which are the highest ranking, viable time slot options. The user interface 700 also presents options to allow the user to open the calendar for more open-ended scheduling (706), accepting the conflict (708), and filtering conflict notifications (710), e.g., exclude conflict notifications relating to calendar conflicts with the user's workout.

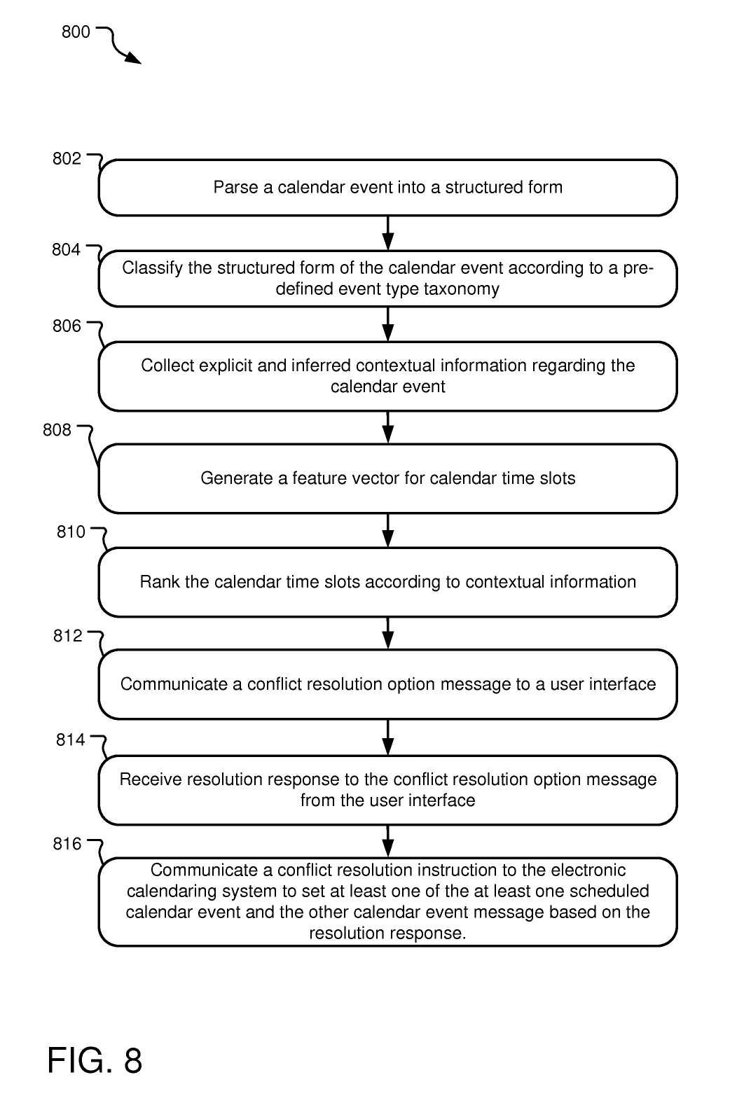

FIG. 8 illustrates example operations 800 for performing contextual calendar conflict resolution. A parsing operation 802 parses the calendar event into a structured form. A classification operation 804 classifies the structured form of the calendar event according to a pre-defined event type taxonomy. A collection operation 806 collects explicit and inferred contextual information regarding the calendar event. Existing explicit parameters, explicit calendar events, inferred calendar events, and user signals may be used to infer new contextual information regarding the calendar event.

A feature vector generation operation 808 generates a feature vector for each calendar time slot. In various implementations, features may be grouped as user features, time slot features, user-timeslot features, as previously described, as well as other groupings.

A ranking operation 810 ranks the calendar time slots according to the feature vectors, which are informed by explicit and/or inferred contextual information. A communication operation 812 communicates one or more ranked time slots as potential calendar conflict resolution options to a computing device with a user interface to solicit user input. A receiving operation 814 receives a resolution response to the calendar conflict resolution message input through the user interface. A calendar conflict resolution implementation operation 816 records the calendar conflict resolution in the one or more databases of the electronic calendaring system, based on the resolution response received in the receiving operation 814.

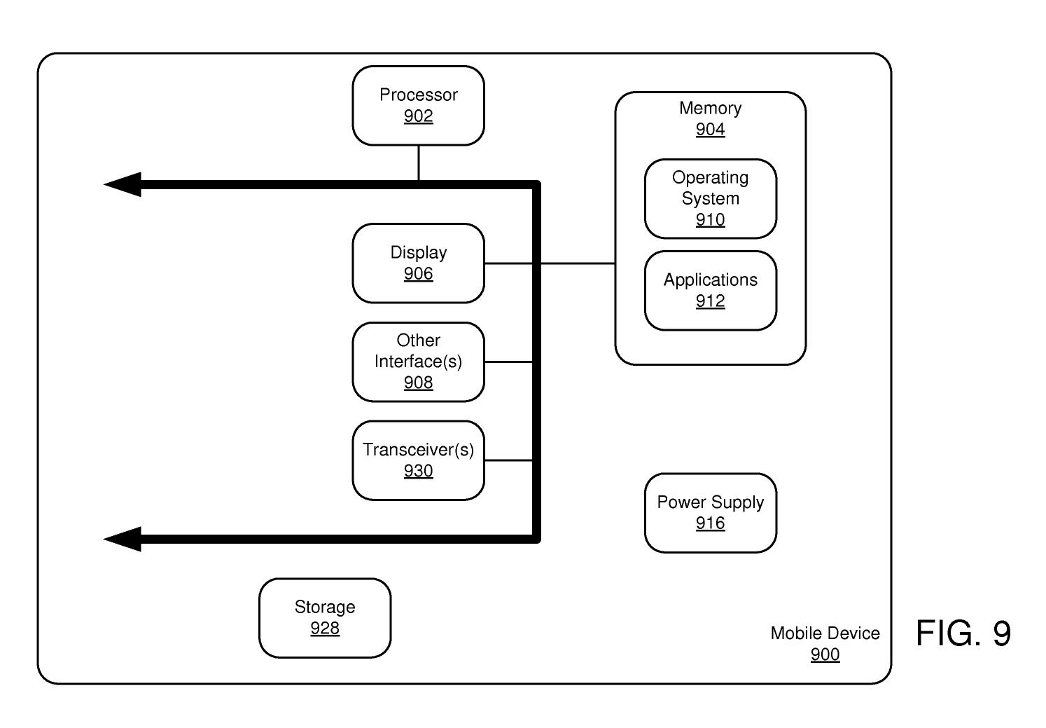

FIG. 9 illustrates an example computing system 900 that may be useful for performing contextual calendar conflict resolution. A computing system, which may be stand-alone, distributed, mobile, or otherwise, includes one or more processors 902, memory 904, a display 906 (e.g., a touchscreen display), and other interfaces 908 (e.g., a keyboard). The memory 904 generally includes both volatile memory (e.g., RAM) and non-volatile memory (e.g., flash memory). An operating system 910, such as the Microsoft Windows® or Windows Phone® operating systems, resides in the memory 904 and is executed by the processor 902, although it should be understood that other operating systems may be employed.

One or more application programs 912 are loaded in the memory 904 and executed on the operating system 910 by the processor 802. Examples of applications 912 include without limitation an electronic calendaring program, a calendar conflict resolution program, a communication program, etc. The computing system 900 includes a power supply 916, which is powered by one or more batteries or other power sources and which provides power to other components of the computing system 900. The power supply 916 may also be connected to an external power source that overrides or recharges the built-in batteries or other power sources. The computing system 900 includes one or more communication transceivers 930 to provide network connectivity (e.g., mobile phone network, Wi-Fi®, BlueTooth®, etc.). Other configurations may also be employed.

In an example implementation, an event conflict evaluator, an event context evaluator, a conflict resolution mediator, a conflict resolution implementer and other computing modules may be embodied by instructions stored in memory 904 and/or storage devices 928 and processed by the processor 902. Explicit calendars, inferred calendars, calendar events, calendar conflict resolution options, explicit and inferred parameters, generated feature vectors, and other data may be stored in memory 904 and/or storage devices 928 as persistent datastores.

The computing system 900 may include a variety of tangible computer-readable storage media and intangible computer-readable communication signals. Tangible computer-readable storage can be embodied by any available physical media that can be accessed by the computing system 900 and includes both volatile and nonvolatile storage media and removable and non-removable storage media. Tangible computer-readable storage media excludes intangible communications signals and includes volatile and nonvolatile, removable and non-removable storage media implemented in any method or technology for storage of information such as computer readable instructions, data structures, program modules or other data. Tangible computer-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information and which can accessed by the computing system 900. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal.

One example electronic calendaring system manages one or more electronic calendar databases for recording one or more calendar events. The electronic calendaring system is configured to generate one or more electronic calendar conflict resolution options based on contextual information associated with conflicting calendar events. An event conflict evaluator is communicatively coupled to the one or more electronic calendar databases and is configured to receive calendar event information from the one or more electronic calendar databases. The event conflict evaluator is configured to identify a calendar conflict between at least two calendar events within the received calendar event information. An event context evaluator is communicatively coupled to the one or more electronic calendar databases and is configured to receive the calendar event information associated with the at least two conflicting calendar events. The event context evaluator is configured to collect contextual information about the at least two conflicting calendar events. A conflict resolution mediator is communicatively coupled to the one or more electronic calendar databases and is configured to receive the calendar event information and the collected contextual information. The conflict resolution mediator is configured to rank available time slots to which at least one of the conflicting calendar events can be rescheduled based on the collected contextual information. The conflict resolution mediator is further configured to communicate a conflict resolution option message via a user interface of a computing device. The conflict resolution option message proposes at least one of the ranked time slots to resolve the calendar conflict.

Another example electronic calendaring system of any previous system includes a conflict resolution implementer is communicatively coupled to the one or more electronic calendar databases and is configured to access the calendar event information in the one or more electronic calendar databases. The conflict resolution implementer is further configured to receive a resolution response to the conflict resolution option message via the user interface and to communicate a scheduling instruction to the electronic calendaring system to schedule at least one of conflicting calendar events based on the resolution response.

Another example electronic calendaring system of any previous system wherein the available time slots are ranked according to one or more feature vectors.

Another example electronic calendaring system of any previous system wherein one or more feature vectors are based on predefined user features.

Another example electronic calendaring system of any previous system wherein one or more feature vectors are based on predefined time slot features.

Another example electronic calendaring system of any previous system wherein one or more feature vectors are based on predefined user-time slot features.

Another example electronic calendaring system of any previous system wherein the two conflicting calendar events include at least one inferred calendar event.

Another example electronic calendaring system of any previous system wherein the event context evaluator parses the calendar event information and transforms the parsed calendar information into a structured form.

Another example electronic calendaring system of any previous system wherein an event context evaluator classifies the calendar event information according to an event type based on a structured form.

Another example electronic calendaring system of any previous system wherein the event context evaluator identifies missing parameters in the calendar event information and infers the missing parameters based on at least explicit calendar event information, inferred calendar event information, or user signals.

An example processor-implemented method generates one or more electronic calendar conflict resolution options based on contextual information associated with conflicting calendar events. A calendar conflict is identified between at least two calendar events within calendar event information stored in one or more electronic calendar databases. Contextual information is collected about the at least two conflicting calendar events. Available time slots to which at least one of the conflicting calendar events can be rescheduled are ranked based on the collected contextual information. A conflict resolution option message is communicated via a user interface of a computing device. The conflict resolution option message proposes at least one of the ranked time slots to resolve the calendar conflict.

Another example processor-implemented method of any previous method includes receiving a resolution response to the conflict resolution option message via the user interface and communicating a scheduling instruction to the one or more electronic calendar databases to schedule at least one of conflicting calendar events based on the resolution response.

Another example processor-implemented method of any previous method wherein the available time slots are ranked according to one or more feature vectors.

Another example processor-implemented method of any previous method wherein one or more feature vectors are based on predefined user features.

Another example processor-implemented method of any previous method wherein one or more feature vectors are based on predefined time slot features.

Another example processor-implemented method of any previous method wherein one or more feature vectors are based on predefined user-time slot features.

Another example processor-implemented method of any previous method wherein the two conflicting calendar events include at least one inferred calendar event.

Another example processor-implemented method of any previous method further includes parsing the calendar event information and transforms the parsed calendar information into a structured form.

Another example processor-implemented method of any previous method further includes identifying missing parameters in the received calendar event information and inferring the missing parameters based on at least explicit calendar event information, inferred calendar event information, or user signals.

One or more tangible computer-readable storage media encode computer-executable instructions for executing on a computer system an example computer process for generating one or more electronic calendar conflict resolution options based on contextual information associated with conflicting calendar events. A calendar conflict is identified between at least two calendar events within calendar event information stored in one or more electronic calendar databases. Contextual information is collected about the at least two conflicting calendar events. Available time slots to which at least one of the conflicting calendar events can be rescheduled are ranked based on the collected contextual information. A conflict resolution option message is communicated via a user interface of a computing device, the conflict resolution option message proposing at least one of the ranked time slots to resolve the calendar conflict.

Another example electronic calendaring system manages one or more electronic calendar databases for recording one or more calendar events. The electronic calendaring system is configured to generate one or more electronic calendar conflict resolution options based on contextual information associated with conflicting calendar events. A calendar conflict is identified between at least two calendar events within calendar event information stored in one or more electronic calendar databases. Contextual information is collected about the at least two conflicting calendar events. Available time slots to which at least one of the conflicting calendar events can be rescheduled are ranked based on the collected contextual information. A conflict resolution option message is communicated via a user interface of a computing device. The conflict resolution option message proposes at least one of the ranked time slots to resolve the calendar conflict.

Another example electronic calendaring system includes means for identifying a calendar conflict between at least two calendar events within calendar event information stored in one or more electronic calendar databases, means for collecting contextual information about the at least two conflicting calendar events, means for ranking available time slots to which at least one of the conflicting calendar events can be rescheduled based on the collected contextual information, and means for communicating a conflict resolution option message via a user interface of a computing device, the conflict resolution option message proposing at least one of the ranked time slots to resolve the calendar conflict.

Another example electronic calendaring system of any previous system further includes means for receiving a resolution response to the conflict resolution option message via the user interface and means for communicating a scheduling instruction to the one or more electronic calendar databases to schedule at least one of conflicting calendar events based on the resolution response.

The implementations of the invention described herein are implemented as logical steps in one or more computer systems. The logical operations of the present invention are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, adding and omitting as desired, unless explicitly claimed otherwise or a specific order is inherently necessitated by the claim language.

The above specification, examples, and data provide a complete description of the structure and use of exemplary embodiments of the invention. Since many implementations of the invention can be made without departing from the spirit and scope of the invention, the invention resides in the claims hereinafter appended. Furthermore, structural features of the different embodiments may be combined in yet another implementation without departing from the recited claims.

What is claimed is:

1. An electronic calendaring system that manages one or more electronic calendar databases for recording one or more calendar events, the electronic calendaring system being configured to generate one or more electronic calendar conflict resolution options based on contextual information associated with conflicting calendar events, the electronic calendaring system comprising:
an event conflict evaluator communicatively coupled to the one or more electronic calendar databases and configured to receive calendar event information from the one or more electronic calendar databases, the event conflict evaluator being configured to identify a calendar conflict between at least two calendar events within the received calendar event information;
an event context evaluator communicatively coupled to the one or more electronic calendar databases and configured to receive the calendar event information associated with the at least two conflicting calendar events, the event context evaluator being configured to collect contextual information about the at least two conflicting calendar events; and
a conflict resolution mediator communicatively coupled to the one or more electronic calendar databases and configured to receive the calendar event information and the collected contextual information, the conflict resolution mediator being configured to rank available time slots to which at least one of the conflicting calendar events can be rescheduled based on the collected contextual information, the conflict resolution mediator being further configured to communicate a conflict resolution option message via a user interface of a computing device, the conflict resolution option message proposing at least one of the ranked time slots to resolve the calendar conflict.

2. The electronic calendaring system of claim 1 further comprising:
a conflict resolution implementer communicatively coupled to the one or more electronic calendar databases and configured to access the calendar event information in the one or more electronic calendar databases, the conflict resolution implementer being further configured to receive a resolution response to the conflict resolution option message via the user interface and to communicate a scheduling instruction to the electronic calendaring system to schedule at least one of conflicting calendar events based on the resolution response.

3. The electronic calendaring system of claim 1 wherein the available time slots are ranked according to one or more feature vectors.

4. The electronic calendaring system of claim 3 wherein the one or more feature vectors are based on predefined user features.

5. The electronic calendaring system of claim 3 wherein the one or more feature vectors are based on predefined time slot features.

6. The electronic calendaring system of claim 3 wherein the one or more feature vectors are based on predefined user-time slot features.

7. The electronic calendaring system of claim 1 wherein the two conflicting calendar events include at least one inferred calendar event.

8. The electronic calendaring system of claim 1 wherein the event context evaluator parses the calendar event information and transforms the parsed calendar information into a structured form.

9. The electronic calendaring system of claim 8 wherein the event context evaluator classifies the calendar event information according to an event type based on the structured form.

10. The electronic calendaring system of claim 1 wherein the event context evaluator identifies missing parameters in the calendar event information and infers the missing parameters based on at least explicit calendar event information, inferred calendar event information, or user signals.

11. A processor-implemented method of generating one or more electronic calendar conflict resolution options based on contextual information associated with conflicting calendar events, the processor-implemented method comprising:
identifying a calendar conflict between at least two calendar events within calendar event information stored in one or more electronic calendar databases;
collecting contextual information about the at least two conflicting calendar events;
ranking available time slots to which at least one of the conflicting calendar events can be rescheduled based on the collected contextual information; and
communicating a conflict resolution option message via a user interface of a computing device, the conflict resolution option message proposing at least one of the ranked time slots to resolve the calendar conflict.

12. The processor-implemented method of claim 11 further comprising:
receiving a resolution response to the conflict resolution option message via the user interface; and
communicating a scheduling instruction to the one or more electronic calendar databases to schedule at least one of conflicting calendar events based on the resolution response.

13. The processor-implemented method of claim 11 wherein the available time slots are ranked according to one or more feature vectors.

14. The processor-implemented method of claim 13 wherein the one or more feature vectors are based on predefined user features.

15. The processor-implemented method of claim 13 wherein the one or more feature vectors are based on predefined time slot features.

16. The processor-implemented method of claim 13 wherein the one or more feature vectors are based on predefined user-time slot features.

17. The processor-implemented method of claim 11 wherein the two conflicting calendar events include at least one inferred calendar event.

18. The processor-implemented method of claim 11 further comprising:
parsing the calendar event information and transforms the parsed calendar information into a structured form.

19. The processor-implemented method of claim 11 further comprising:
identifying missing parameters in the received calendar event information; and
inferring the missing parameters based on at least explicit calendar event information, inferred calendar event information, or user signals.

20. One or more tangible computer-readable storage media encoding computer-executable instructions for executing on a computer system a computer process for generating one or more electronic calendar conflict resolution options based on contextual information associated with conflicting calendar events, the computer process comprising:
identifying a calendar conflict between at least two calendar events within calendar event information stored in one or more electronic calendar databases;
collecting contextual information about the at least two conflicting calendar events; and
ranking available time slots to which at least one of the conflicting calendar events can be rescheduled based on the collected contextual information; and
communicating a conflict resolution option message via a user interface of a computing device, the conflict resolution option message proposing at least one of the ranked time slots to resolve the calendar conflict.
